(19) United States
(12) Patent Application Publication
(10) Pub. No.: US 2023/0078203 A1
(43) Pub. Date: Mar. 16, 2023

(54) CONFIGURABLE NONLINEAR ACTIVATION FUNCTION CIRCUITS

(71) Applicant: QUALCOMM Incorporated, San Diego, CA (US)

(72) Inventors: Ren LI, San Diego, CA (US); Prajakt KULKARNI, San Diego, CA (US); Suren MOHAN, San Diego, CA (US); Aaron Douglass LAMB, San Diego, CA (US)

(21) Appl. No.: 17/467,079

(22) Filed: Sep. 3, 2021

(51) Int. Cl. G06N 3/04; G06N 3/063; G06F 1/03

(52) U.S. Cl. CPC G06N 3/0481; G06N 3/063; G06F 1/0307

(57) ABSTRACT

Certain aspects of the present disclosure provide a method for processing input data by a configurable nonlinear activation function circuit, including determining a nonlinear activation function for application to input data; determining, based on the determined nonlinear activation function, a set of parameters for a configurable nonlinear activation function circuit; and processing input data with the configurable nonlinear activation function circuit based on the set of parameters to generate output data.

### INTRODUCTION

Aspects of the present disclosure relate processing nonlinear activation functions for machine learning models, and in particular to configurable nonlinear activation function circuits.

Machine learning is generally the process of producing a trained model (e.g., an artificial neural network), which represents a generalized fit to a set of training data. Applying the trained model to new data enables production of inferences, which may be used to gain insights into the new data.

As the use of machine learning has proliferated for enabling various machine learning (or artificial intelligence) tasks, the need for more efficient processing of machine learning model data has arisen. In some cases, dedicated hardware, such as machine learning (or artificial intelligence) accelerators or processors or similar circuits, may be used to enhance a processing system's capacity to process machine learning model data. For example, processing data with a nonlinear activation function may be distributed to a processor other than the primary matrix multiplication processor. However, distributing various aspects of processing a machine learning model across different processing devices may incur latency, memory use, power use, and other processing penalties.

Accordingly, there is a need for improved techniques for processing machine learning model data with nonlinear activation functions.

### BRIEF SUMMARY

Certain aspects provide a processor, comprising: a configurable nonlinear activation function circuit configured to: determine a nonlinear activation function for application to input data; determine, based on the determined nonlinear activation function, a set of parameters for the nonlinear activation function; and generate output data based on application of the set of parameters for the nonlinear activation function.

Further aspects provide a method for processing input data by a configurable nonlinear activation function circuit, comprising: determining a nonlinear activation function for application to input data; determining, based on the determined nonlinear activation function, a set of parameters for a configurable nonlinear activation function circuit; and processing input data with the configurable nonlinear activation function circuit based on the set of parameters to generate output data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example configurable nonlinear activation (CNLA) function circuit.

FIG. 2 depicts example circuit blocks for implementing bypassable approximator blocks, such as described with respect to FIG. 1.

FIG. 3 depicts an example approximator.

FIG. 4 depicts an example machine learning model process flow.

FIG. 5 depicts an example method for performing processing using a configurable nonlinear activation function circuit.

FIG. 6 depicts an example processing system that may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide improved techniques for processing nonlinear activation functions associated with machine learning models.

Nonlinear activations are key components of various types of machine learning models, including neural network models. While some nonlinear activation functions are implemented as piecewise linear functions (e.g., rectified linear unit (ReLU), leaky ReLU, and others), other nonlinear activations functions require complex mathematical functions (e.g., sigmoid, hyperbolic tangent (tanh), and others). In some cases, the complex mathematical functions may be implemented using interpolation, such as cubic spline interpolation.

Conventionally, nonlinear activation functions may be implemented in software rather than hardware owing to the wide range of possible activation functions usable in machine learning models. However, such implementations typically require moving model data between processing devices (e.g., between a neural processing unit (NPU) performing matrix multiplication and accumulation and a digital signal processor (DSP) processing the nonlinear activation function), thus incurring power and latency penalties. Where nonlinear activation functions have been implemented in hardware, they have generally been limited to supporting only a small number of nonlinear activation functions and thus cannot be configured to support evolving machine learning model architectures without falling back to outsourcing the nonlinear activation function processing to a distributed processing unit.

For example, the rectified linear unit (ReLU) is a commonly used activation function in deep learning models. The function returns 0 if it receives a negative input, and returns the input, x, other. Thus it can be written as ƒ(x)=max(0, x) . ReLU functions are generally not implemented by the primary matrix multiplication and accumulation processing unit, such as a compute-in-memory (CIM) array in some examples. Thus, the need to distribute the ReLU function, or another nonlinear activation function, is costly from a processing standpoint. Moreover, as the activation function gets more complex, the cost likewise gets more complex (e.g., for performing relatively higher power exponential and division operations that are part of certain nonlinear activation functions, as described further below).

To overcome the shortcomings of conventional solutions, aspects described herein relate to a configurable nonlinear activation (CNLA) function circuit that may be implemented in hardware for efficient processing. In particular, because it can be implemented in hardware, the CNLA function may be collocated with other processing circuits optimized for other machine learning model processing tasks, such as CIM arrays and digital multiply-and-accumulate (DMAC) circuits that are optimized for performing vector and matrix multiplication and accumulation functions.

In order to improve processing efficiency, aspects described herein may use polynomial approximations to approximate complex functions, such as may be used within nonlinear activation functions. In some cases, aspects described herein may use series expansions, such as a Taylor series. Generally, a Taylor series of a function (e.g., ƒ(x)) is an infinite sum of terms that are expressed in terms of the function's derivatives at a single point. For many functions, the function and the sum of its Taylor series are equal near this point. The partial sum formed by the first n+1 terms of a Taylor series is a polynomial of degree n that is referred to as the nth Taylor polynomial of the function. Thus, Taylor polynomials allow for processing efficient approximations of a function, which become generally better as n increases.

The CNLA function circuits described herein may implement one or more polynomial approximation blocks, such as cubic approximation blocks, which generally enhance cubic spline interpolation to make it more efficient and more generalized to cover a wider variety of nonlinear activation functions. Moreover, the CNLA function circuits may be implemented as a pipelined digital block that can use nonlinearly segmented look-up tables (LUTs) and mixed orders of approximations (e.g., pipelined linear, quadratic, and cubic approximations). Thus, the CNLA function circuits described herein can be configured to meet many different performance goals, unlike conventional nonlinear activation function circuits.

Accordingly, the CNLA function circuits described herein provide a technical solution to the technical problem of implementing a wide range of nonlinear activation functions in machine learning model processing systems. Further, the CNLA function circuits described herein provide a technical improvement by way of increased model processing performance compared to existing solutions, including lower latency, lower power use, improved memory efficiency, and others as described herein.

### Example Configurable Nonlinear Activation Function Circuit

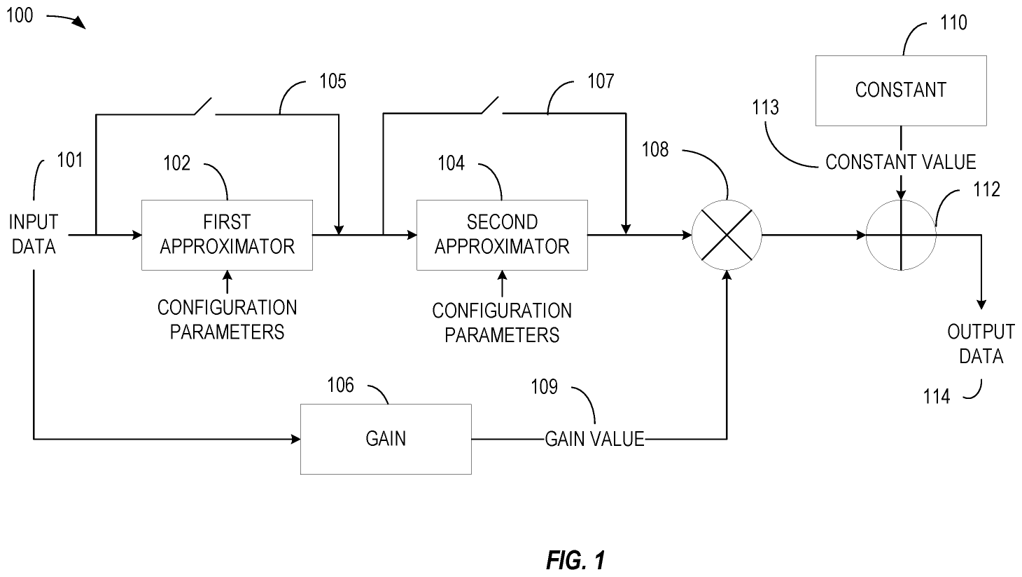

FIG. 1 depicts an example configurable nonlinear activation (CNLA) function circuit 100.

Generally, CNLA function circuit 100 may be configured to receive input data 101 (e.g., an output value from a layer of a machine learning model) and to perform various nonlinear activation functions to generate output data 114 (e.g., “activations”). CNLA function circuit 100 may be collocated and pipelined with other machine learning model processing circuits, such as a CIM array, DMAC, and others, and may be configured to perform activation functions based on the output of the other machine learning model processing circuits.

In some examples, input data 101 may be received from a buffer or other memory. In other examples, input data 101 may be received directly from the output of another processing block, such as the output of a CIM array or another vector and matrix multiplication and accumulation block, or the like.

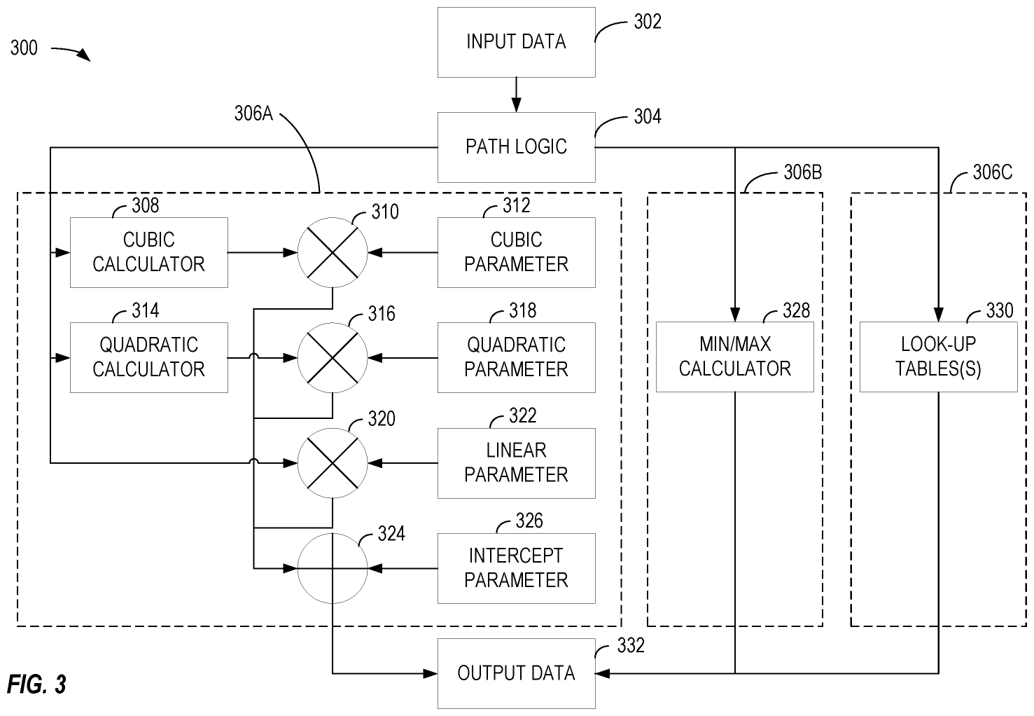

CNLA function circuit 100 includes a first approximator block 102, which may generally be configured to perform a hardware-based mathematical function, such as on input data 101. An example approximator is described in detail with respect to FIG. 3.

In some cases, first approximator is one of a linear approximator (e.g., configured to perform a function, such as ax+b), a quadratic approximator (e.g., configured to perform a function, such as axe+bx+c), or a cubic approximator (e.g., configured to perform a function, such as ax³+bx²+cx+d), where x is the input data and a, b, c, and dare configurable parameters. First approximator 102 may be configured with parameters, retrieved from, for example, a memory, a register, a look-up table, or the like. As described in further detail below with respect to Table 2, these different forms of approximation and associated configurable parameters can be used to approximate many types of nonlinear activation functions.

CNLA function circuit 100 further includes a second approximator block 104, which like first approximator block 102, may generally be configured to perform a hardware-based mathematical function, such as a linear, quadratic, or cubic function. As described in more detail below, CNLA function circuit 100 may be configured to use first approximator block 102 and second approximator block 104 in series for more complex functions, such that the output of first approximator block 102 becomes input to second approximator block 104. CNLA function circuit 100 may be further configured to use only one of first approximator block 102 or second approximator block 104 when a simpler nonlinear function is being processed, thereby saving power.

In some implementations, first approximator 102 and second approximator 104 may comprise the same circuit block (e.g., two instances of the same circuit elements within circuit 100), and in such cases, each of first approximator 102 and second approximator 104 may be cubic approximators. In other implementations, first approximator 102 and second approximator 104 may comprise different circuit elements, and in such cases, generally second approximator 104 will comprise a cubic approximator and first approximator 102 will comprise a lower order approximator, such as a quadratic or linear approximator. However, in other embodiments, the order of the higher and lower order approximators may be reversed.

CNLA function circuit 100 includes a configurable bypass 105, which allows first approximator 102 to be bypassed in various scenarios, such as if a function only requires a lower order approximator than first approximator 102 and second approximator 104 is such a lower order approximator. When, for example, first approximator 102 is bypassed via configurable bypass 105, then input data 101 is provided directly to second approximator 104 instead and not processed by first approximator 102.

CNLA function circuit 100 further includes another configurable bypass 107, which allows second approximator 104 to be bypassed in various scenarios, such as if a function only requires a first approximation, which first approximator 102 is capable of performing without second approximator 104. When, for example, second approximator 104 is bypassed via configurable bypass 107, the output of first approximator 102 is provided directly to multiplier 108.

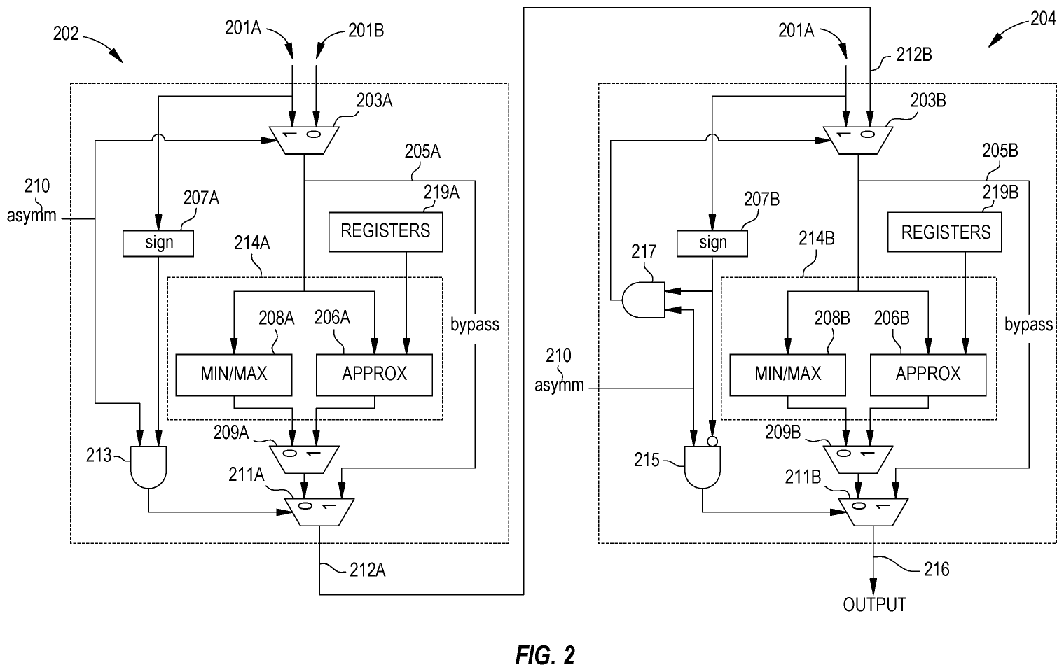

Generally, configurable bypasses 105 and 107 allow CNLA function circuit 100 to be configured for maximum versatility, while saving power and avoiding unnecessary circuit block processing in various scenarios. Further, configurable bypasses allow for non-symmetric and anti-symmetric nonlinear activation functions to be configured for processing by CNLA function circuit 100. FIG. 2 depicts example circuit aspects for implementing configurable bypasses 105 and 107.

CNLA function circuit 100 further includes a gain block 106 configured to provide a gain value to multiplier 108. In some aspects, gain block 106 is configured to generate a gain value 109 based on a gain function implemented by gain block 106. In one example, the gain function may be in the form g=ax+b, where g is the gain value, x is the input data 101 value, and a and b are configurable parameters. The gain value 109 generated by gain block 106 is multiplied with the output of first and/or second approximators 102 and 104 via multiplier 108. In other aspects, gain block 106 may be configured with a gain value that is not based on a function of input data 101. Generally, the parameters (e.g., a and b in the example above) or value for gain block 106 may be retrieved from, for example, a memory, a register, a look-up table, or the like.

CNLA function circuit 100 further includes a constant block 110 configured to store a constant value 113 and adder 112 configured to add the constant value 113 to the output of multiplier 108 (e.g., a gain multiplier). The constant value 113 stored in constant block 110 may be retrieved from, for example, a memory, a register, a look-up table, or the like.

The inclusion and arrangement of first approximator block 102, second approximator block 104, configurable bypasses 105 and 107, gain block 106, multiplier 108, constant block 110, and adder 112 allows for CNLA function circuit 100 to be configured to perform a wide variety of known and later developed nonlinear activation functions. Moreover, CNLA function circuit 100 may be efficiently configured to process a wide variety of nonlinear activation functions by merely updating parameters for the first approximator 102, second approximator 104, gain block 106, and constant block 110. When both approximator blocks 102 and 104 are used to simulate a nonlinear function, each may be referred to as performing an individual function (e.g., a first function for the first approximator block 102 and a second function for the second approximator 104). This design beneficially supports arbitrary non-symmetric nonlinear curves for complex functions.

Table 1, below, provides example parameters for various nonlinear activation functions that CNLA function circuit 100 of FIG. 1 can be configured to perform, including parameters for approximator blocks 206A and 206B of FIG. 2. In Table 1, the gain is considered to have the form ax+b, as is in the example of gain block 106 in FIG. 1, but note that in other embodiments, the gain may be a scalar value, or a different functional form. Similarly, a quadratic approximator is considered to have the form ax²+bx+c and a cubic approximator is considered to have the form ax³+bx²+cx+d. In the following table, subscripts are used to indicate parameter assignments, e.g., G for gain parameters, 1 for first approximator, and 2 for second approximator parameters.

TABLE 1

| Nonlinear | | |
|---|---|---|
| Activation Function | Form | Parameters |
| ReLU | ReLU(x) = max(0, x) | Asymmetric = 0 |
| | | Gain: (a_{G} = 0, b_{G} = 1) |
| | | Constant = 0 |
| | | First Approximator → |
| | | quadratic parameters |
| | | {a₁ = 0, b₁ = 1, c₁ = 0} |
| | | Second approximator → |
| | | max function |
| ReLU6 | ReLU6(x) = min(max(0, x), 6) | Asymmetric = 0 |
| | | Gain: (a_{G} = 0, b_{G} = 1) |
| | | Constant = 0 |
| | | First Approximator → |
| | | max function |
| | | Second Approximator → |
| | | min function |
| Swish | swish(x) = x · sigmoid (x) | Asymmetric = 0 |
| | | Gain: (a_{G} = 1, b_{G} = 0) |
| | | Constant = 0 |
| | | First Approximator → |
| | | quadratic parameters |
| | | {a₁ = 0, b₁ = 1, c₁ = 0} |
| | | Second Approximator → |
| | | sigmoid look-up table |
| Hard Swish | $hswish ( x ) = x \frac{ReLU 6 ( x + 3 )}{6}$ | Asymmetric = 0 $Gain : ( {a}_{G} = \frac{1}{6} , {b}_{G} = 0 )$ |
| | | Constant = 3 |
| | | First Approximator→ |
| | | max function |
| | | Second Approximator → |
| | | min function |
| Hyperbolic Tangent | $tanh ( x ) = \frac{{e}^{x} - {e}^{- x}}{{e}^{x} + {e}^{- x}}$ | Asymmetric = 0 Gain: (a_{G} = 0, b_{G} = 1) |
| | | Constant = 0 |
| | | First Approximator → |
| | | Quadratic parameters |
| | | {a₁ = 0, b₁ = 1, c₁ = 0} |
| | | Second Approximator → |
| | | tanh look-up table |
| Sigmoid | $σ ( x ) = \frac{{e}^{x}}{1 + {e}^{x}}$ | Asymmetric = 0 Gain: (a_{G} = 0, b_{G} = 1) |
| | | Constant = 0 |
| | | First Approximator → |
| | | linear parameters |
| | | {a₁ = 1, b₁ = 0} |
| | | Second approximator → |
| | | sigmoid look-up table |
| GELU | $GELU ( x ) \approx 1 + tanh [ \sqrt{\frac{2}{π}} ( x + 0.044 \; 715 {x}^{3} ) ]$ | Asymmetric = 0 Gain: (a_{G} = 0, b_{G} = 1) Constant = 1 |
| | | First Approximator → |
| | | cubic parameters |
| | | $GELU ( x ) \approx 1 + tanh [ \sqrt{\frac{2}{π}} ( x + 0.044 \; 715 {x}^{3} ) ]$ |
| | | Second Approximator → |
| | | tanh look-up table |
| GELU variant | GELU(x) ≈ x * σ(1.702x) | Asymmetric = 0 |
| | | Gain: (a_{G} = 1, b_{G} = 0) |
| | | Constant = 0 |
| | | First Approximator → |
| | | quadratic parameters |
| | | {a₁ = 0, b₁ = 1.072, c₁ = |
| | | 0} |
| | | Second approximator → |
| | | sigmoid look-up table |
| ELU | $ELU ( x ) = \{ \begin{matrix}x & x > 0 \\ α ( {e}^{x} - 1 ) & x \leq 0\end{matrix}$ | Asymmetric = 1 Gain: (a_{G} = 0, b_{G} = α) |
| | | Constant = 0 |
| | | For x ≥ 0: |
| | | {First Approximator → |
| | | quadratic parameters |
| | | {a₁ = 0, b₁ = 1/α, c₁ = |
| | | 0} |
| | | Second approximator → |
| | | Bypass} |
| | | For x < 0: |
| | | {First Approximator → |
| | | Bypass |
| | | Second approximator → |
| | | exponential look-up |
| | | table} |

Note that in the ELU function above, the a parameter may be configured as a hyperparameter by a model designer.

Notably, in some implementations, parameters for an approximator may be given in a form (e.g., cubic with a, b, c, and d parameters or quadratic with a, b, and c parameters), even where the approximator is performing a lower order function (e.g., linear). This is because setting, for example, the cubic parameter a to zero effectively collapses the approximation equation to a lower order quadratic function, and likewise setting the quadratic parameter a to zero effectively collapses the approximation equation to a linear equation. Thus, an approximator may be configured, for example, for a “quadratic function” when it is configured with quadratic parameters, but the result of the parameters may reduce the function to a linear function, as in the example of ReLU above in Table 2. This may allow standardization of the parameter set despite the order of the underlying function to be configured by the parameters, thereby simplifying the implementation.

FIG. 2 depicts example circuit blocks 202 and 204 for implementing bypassable approximator blocks 206A and 206B, which may correspond to first approximator block 102 and second approximator block 104 of FIG. 1 in one example.

In FIG. 2, circuit block 202 is configured to control use of function block 214A, which includes first approximator 206A and minimum and maximum function block 208A in this example. Similarly, circuit block 204 controls use of function block 214B, which includes minimum and maximum function block 208B and second approximator 206B, in this example. The first and second approximator blocks 206A and 206B may be configured to implement nonlinear activation functions, such as those described above with respect to Table 1.

Note that the first approximator 102 in FIG. 1 requires only one input, but circuit block 202 includes two input ports, 201A and 201B, which allows for multiple inputs. The depicted configuration of circuit block 202 may be adopted in order to present the same external interface for both circuit blocks 202 and 204, which may simplify configuration and integration, even if they are configured to implement approximator blocks in series as in FIG. 1. In some aspects, the two input ports 201A and 201B of circuit block 202 may be tied together in an implementation where circuit block 202 receives a single input (such as input data 101 in FIG. 1) via input port 201A. In an alternative implementation, circuit block 202 can be simplified by removing input port 201B and removing input mux 203A.

Generally, input ports 201A and 201B may receive various types of input data for processing, including signed multibit integer data. In one example, the input data is 8-bit 2 s complement input data.

Input selector muxes 203A and 203B are configured to control which input data port is used for circuit blocks 202 and 204, respectively. For example, input selector mux 203B may select between input data port 201A (e.g., when circuit block 202 is being bypassed) or 212B (e.g., when circuit blocks 202 and 204 are being processed in series).

Bypass selector muxes 211A and 211B are configured to control bypassing function blocks 214A and 214B of circuit blocks 202 and 204, respectively. For example, when circuit block 202 is to be bypassed, bypass selector mux 211A selects bypass line 205A to provide an output to output port 212A. Similarly, when circuit block 204 is to be bypassed, bypass selector mux 211B selects bypass line 205B to provide an output to output port 216. Thus, processing with circuit block 202 and/or 204, as controlled by the configurable bypasses 205A and 205B, results in an output at output port 216.

As discussed in more detail with respect to FIG. 3, each circuit block (202 and 204) includes an approximator block (206A for circuit block 202 and 206B for circuit block 204) for input data processing. Approximator blocks 206A and 206B may be configured with configuration parameters (e.g., function specific coefficients as in Table 1, above) stored in registers 219A and 219B, respectively. Similarly, as in Table 1, above, where approximator blocks 206A or 206B are configured to perform a look-up table-based function, the table values may be stored in registers 219A and 219B, respectively.

Each circuit block (202 and 204) further includes a minimum and maximum function block (208A for circuit block 202 and 208B for circuit block 204) for providing minimum and maximum functions. Generally, a minimum (or “min”) function will return the minimum value of the provided inputs. Similarly, a maximum (or “max”) function will return the maximum value of the provided inputs. In one example, minimum and maximum function blocks 208A and 208B may comprise multibit digital comparators that run in either a single cycle or multi-cycle mode.

The configuration of function blocks 214A and 214B may include a setting for function selector muxes 209A and 209B, respectively. In other words, whether or not function blocks 214A and 214B output a min/max output from mix/max blocks 208A and 208B or a value from approximators 206A and 206B is based on the configuration of function selector muxes 209A and 209B. Note that in other examples, function blocks 214A and 214B may include additional function blocks that may be selected by a mux.

As depicted in FIG. 1 where approximator blocks can be processed in series, in FIG. 2 the output 212A of circuit block 202A, which includes a first approximator block 206A, is provided as an input 212B to circuit block 204, which includes a second approximator block 206B. As in FIG. 1 where bypasses 105 and 107 control use of the first and second approximator blocks 102 and 104, here the selectable bypasses 205A and 205B control use of approximator blocks 206A and 206B.

An asymmetric signal line 210 controls a configuration of the circuit blocks 202 and 204. In one example, circuit blocks 202 and 204 are configured based on values on asymmetric signal line 210 and output values from sign blocks 207A and 207B based on the input data received via input data port 201A. For example, the binary value received via the asymmetric signal line 210 and the binary value output from sign block 207A interact at AND gate 213 to control the selection of output by mux 211A. As another example, the binary value received via the asymmetric signal line 210 and the binary value output from sign block 207B interact at AND gate 217 to control the selection of an input data port (as between 201A and 212B) via mux 203B. As a further example, the binary value received via the asymmetric signal line 210 and the inverted binary value output from sign block 207B interact at and gate 215 to control the selection of output mux 211B.

Table 2, below, provides a summary of configurations for circuit blocks 202 and 204:

TABLE 2

| Sign of | | Bypass | Bypass | First | Second |
|---|---|---|---|---|---|
| Input | Asymm | First | Second | Approximator | Approximator |
| Data at | Value | Approximator | Approximator | (206A) | (206B) |
| 201A | (210) | (202) | (204) | Output | Output |
| Positive | 1 | No | Yes | Nonlinear | Bypassed per |
| Sign | | | | based on | 205B |
| block | | | | configured | |
| (207A or | | | | nonlinear | |
| 207B) | | | | activation | |
| output = 0 | | | | function if | |
| | | | | input value | |
| | | | | x ≥ 0 | |
| Negative | 1 or 0 | Yes | No | Bypassed per | Nonlinear |
| Sign | | | | bypass 205A | based on |
| block | | | | | configured |
| (207A or | | | | | nonlinear |
| 207B) | | | | | activation |
| output = 1 | | | | | function if |
| | | | | | input value |
| | | | | | x < 0 |
| Positive | 0 | No | No | Nonlinear | Nonlinear |
| or | | | | based on | based on |
| Negative | | | | configured | configured |
| | | | | nonlinear | nonlinear |
| | | | | activation | activation |
| | | | | function | function |

### Example Approximator for Configurable Nonlinear Activation Function Circuit

FIG. 3 depicts an example approximator 300, which may be an example of one or both of first approximator 102 and second approximator 104 of FIG. 1.

Approximator 300 receives input data 302 (e.g., pre-activation data) for processing. In some examples, input data 302 may be received from a buffer or other memory. In other examples, input data may be received directly from the output of another processing block, such as the output of a CIM array or another vector and matrix multiplication and accumulation block. Further, input data may be received from another approximator, such as if approximator 300 is the second approximator 104 in FIG. 1.

In some implementations, an approximator (such as 300) may include alternative processing paths. In such cases, path logic 304 may be configured to route input data 302 to the appropriate processing path based on, for example, a configuration parameter for approximator 300.

In this example, processing path 306A provides a cubic approximation path for input data 302.

In processing path 306A, input data 302 is provided to cubic calculator 308, which performs a cubic operation (e.g., x³, where x is the input data) and then the output is multiplied with cubic parameter 312 at multiplier 310. The output of multiplier 310 is then provided to accumulator 324.

Input data 302 is also provided to quadratic calculator 308, which performs a quadratic operation (e.g., x², where x is the input data) and then the output is multiplied by quadratic parameter 318 at multiplier 316. The output of multiplier 316 is then provided to accumulator 324.

Input data 302 is also provided to multiplier 320 where it is multiplied by linear parameter 322. The output of multiplier 320 is then provided to accumulator 324.

Accumulator (adder) 324 accumulates the outputs of multipliers 310, 316, and 320 as well as intercept parameter 326 to generate output data 332.

Cubic parameter 312, quadratic parameter 318, linear parameter 322 and intercept parameter 326 may all be stored in a memory or the like (e.g., in registers) accessible to accumulator 300. In some cases, a control unit, such as a memory control unit or finite state machine, may configure approximator 300 with parameters stored in the memory. In various examples, cubic parameter 312, quadratic parameter 318, linear parameter 322 and intercept parameter 326 may be set according to values described above with respect to Table 2.

As above, the order of the approximation can be configured by configuring the aforementioned parameter values. For example, for approximator 300 to perform a quadratic approximation, cubic parameter 312 can be set to zero. Similarly, for approximator 300 to perform a linear approximation, cubic parameter 312 and quadratic parameter 318 can be set to zero.

Certain nonlinear activation functions require alternative functions, such as minimum and maximum functions. Accordingly, processing path 306B provides a minimum and/or maximum calculator that may be used, for example, with the ReLU and ReLU6 functions described above in Table 2. Processing path 306B may be selected by path logic 304 based on configuration data for approximator 300.

Further, certain nonlinear activation functions may be implemented using look-up tables, which provide a more power and time efficient mechanism for generating values for certain nonlinear activation functions. Accordingly, processing path 306C provides a look-up table-based processing path that may be used, for example, wherever a sigmoid, tanh, or similar function is used by a nonlinear activation function. Note that sigmoid and tanh may be calculated from each other, so in some cases, only a single look-up table (e.g., sigmoid or tanh, but not both) is stored and used to implement both functions. One or more look-up tables may be stored in a memory and accessible to approximator 300, including a memory tightly coupled to approximator 300.

### Example Machine Learning Model Process Flow with Configurable Nonlinear Activation Function Circuit

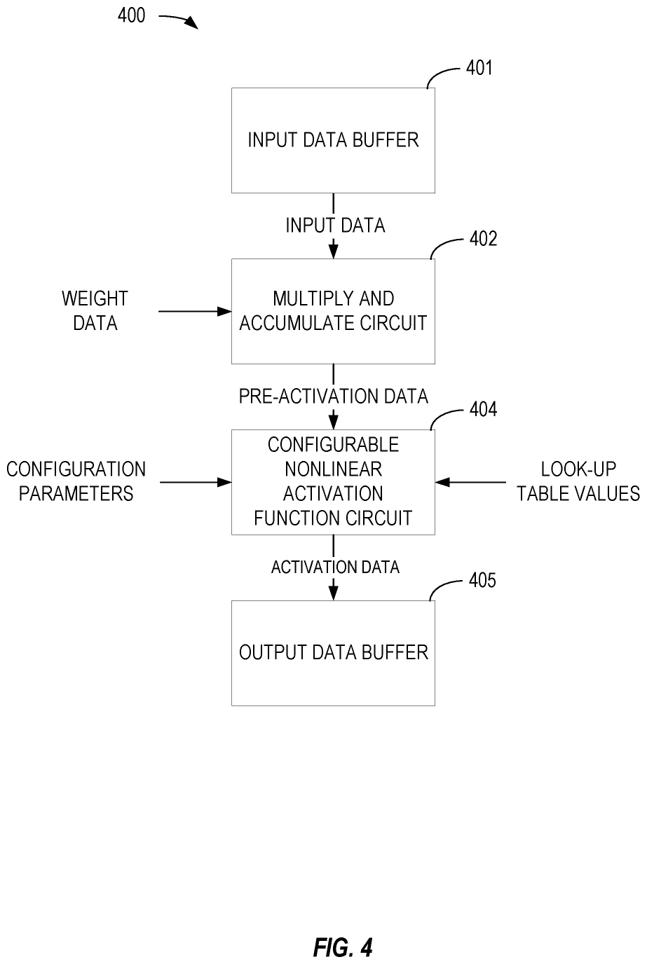

FIG. 4 depicts an example machine learning model data flow 400 that implements a configurable nonlinear activation function circuit, such as described above with respect to FIGS. 1-3.

In flow 400, input data is stored in an input data buffer 401 (e.g., machine learning model layer input data) and then provided to a multiply and accumulate (MAC) circuit 402. MAC circuit 402 may generally be configured to perform vector, array, and matrix multiplication and accumulation operations, such as those used frequently in convolutional neural networks. In some examples, MAC circuit 402 may include one or more compute-in-memory (CIM) arrays. Alternatively, or additionally, MAC circuit 402 may include a digital multiply and accumulate (DMAC). In yet further examples, multiply and accumulate circuit 402 may be a portion of a machine learning accelerator, such as a neural processing unit (NPU), or another type of processing unit optimized for performing machine learning processing. In another implementation, MAC circuit 402 may be replaced by a vector/matrix or matrix/matrix processing engine.

MAC circuit 402 processes the input data with weight data (e.g., neural network weight data) to generate pre-activation data. For example, MAC circuit 402 may process input data to a layer of a neural network model and generate pre-activation data as an output.

The pre-activation data is provided to configurable nonlinear activation (CNLA) function circuit 404, which is configured to generate output data (e.g., activations) based on a configured nonlinear activation function. The output data may then be stored in output data buffer 405 for subsequent use, such as for processing another layer in a machine learning model, or as output from the machine learning model, and the like.

CNLA function circuit 404 may be configured with configuration parameters, such as described with respect to CNLA function circuit 300 in FIG. 3 and those described in Tables 1 and 2. Further, CNLA function circuit 404 may be configured to access look-up tables depending on the configured activation function.

In some cases, configuration parameters may include identification of a nonlinear activation function to be applied to the input data. Based on the determined nonlinear activation function, appropriate parameters (such as those in Table 2) may be retrieved from a memory (e.g., registers) and applied to CNLA function circuit 404 thereby configuring it for processing the input data. In some examples, a finite state machine, a memory control unit, or another controller, may perform the configuration of CNLA function circuit 404.

Notably, CNLA circuit 404 may be configured to process multiple batches of input data using the same configuration, or may update its configuration for every new batch of input data. Thus, CNLA circuit 404 provides a very flexible and efficient means for performing configurable nonlinear activations for machine learning tasks, such as training and inferencing.

### Example Method for Performing Processing Using a Configurable Nonlinear Activation Function Circuit

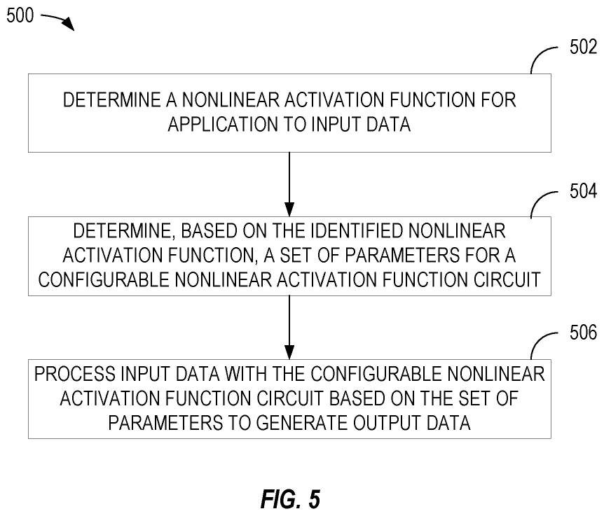

FIG. 5 depicts an example method 500 for performing processing using a configurable nonlinear activation function circuit.

Method 500 begins at step 502 with determining a nonlinear activation function for application to input data. For example, the nonlinear activation function may be one of the functions listed in Table 2, or another nonlinear activation function.

Method 500 then proceeds to step 504 with determining, based on the determined nonlinear activation function, a set of parameters for a configurable nonlinear activation function circuit. For example, the parameters for the determined nonlinear activation function may be as above in Tables 1 and 2.

Method 500 then proceeds to step 506 with processing input data with the configurable nonlinear activation function circuit based on the set of parameters to generate output data. For example, the output data may be activation data for a layer of a neural network model.

In some examples, the set of parameters includes a combination of one or more gain parameters, a constant parameter, and one or more approximation functions to apply to the input data via the configurable nonlinear activation function circuit. For example, the set of parameters may be as discussed above with respect to FIGS. 1 and 2 and in Table 1.

In some examples, method 500 further includes retrieving the set of parameters from a memory based on the determined nonlinear activation function. In some examples, the memory may be one or more registers storing the parameter values.

In some examples, the configurable nonlinear activation function circuit includes a first approximator configured to approximate a first function of the one or more approximation functions; a second approximator configured to approximate a second function of the one or more approximation functions; a first gain multiplier configured to multiply a first gain value based on one or more gain parameters; and a constant adder configured to add a constant value, such as depicted and described with respect to FIG. 1.

In some examples, the configurable nonlinear activation function circuit includes a first bypass configured to bypass the first approximator. In some examples, the configurable nonlinear activation function circuit includes a second bypass configured to bypass the second approximator. In some examples, the configurable nonlinear activation function circuit includes an input data bypass configured to bypass the first approximator and to provide input data to the second approximator.

In some examples, at least one of the first approximator and the second approximator is a cubic approximator. In some examples, an other one of the first approximator and the second approximator is one of a quadratic approximator or a linear approximator. In some examples, an other one of the first approximator and the second approximator is configured to perform a min or max function, such as depicted with respect to path 306B in FIG. 3. In some examples, an other one of the first approximator and the second approximator is configured to access a look-up table for an approximated value, such as depicted with respect to path 306C in FIG. 3.

In some examples, both the first approximator and the second approximator are cubic approximators.

Note that FIG. 5 is just one example, and in other examples, methods such as those described herein, may be implemented with more, fewer, and/or different steps.

### Example Processing System

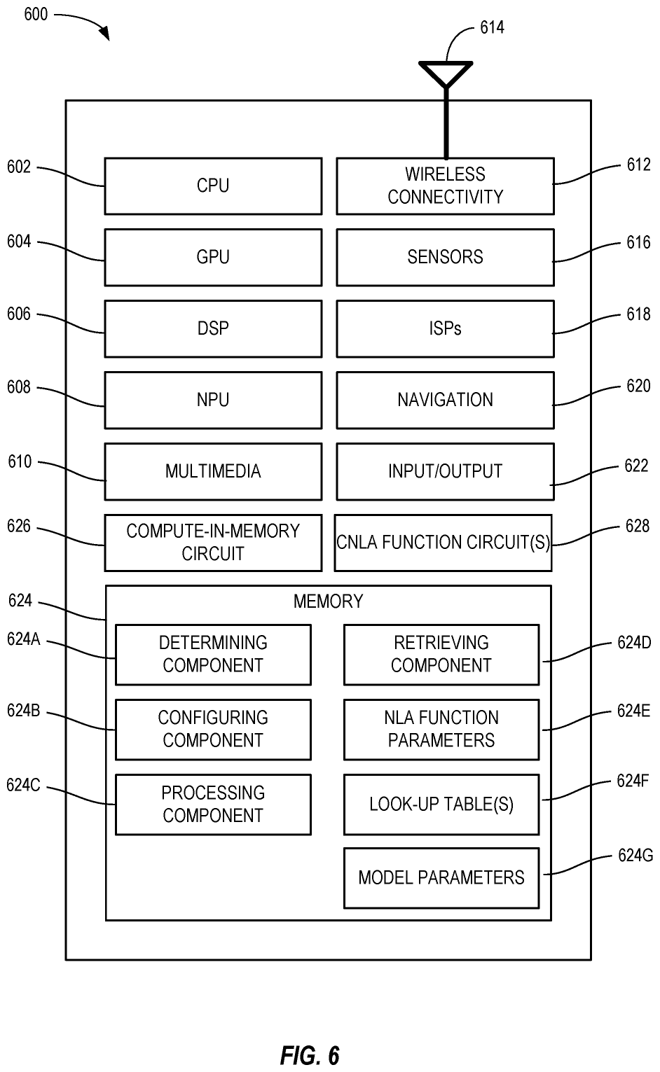

FIG. 6 depicts an example processing system 600 that may be configured to perform the methods described herein, such as with respect to FIGS. 4-5.

Processing system 600 includes a central processing unit (CPU) 602, which in some examples may be a multi-core CPU. Instructions executed at the CPU 602 may be loaded, for example, from a program memory associated with the CPU 602 or may be loaded from memory partition 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as 608, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 608, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some embodiments, NPU 608 may be implemented as a part of one or more of CPU 602, GPU 604, and/or DSP 606.

In some embodiments, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 612 is further connected to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes various circuits in accordance with the various embodiments described herein.

In this example, processing system 600 includes compute-in-memory (CIM) circuit 626, which may be configured to perform efficient multiply-and-accumulate (MAC) functions for processing machine learning model data. Processing system 600 further includes configurable nonlinear activation (CNLA) function circuit 628. In some cases, CNLA function circuit 628 may be like CNLA function circuit 200 described with respect to FIG. 2. CNLA function circuit 628, as well as others not depicted, may be configured to perform various aspects of the methods described herein, such as method 400 with respect to FIG. 4.

In some examples, CNLA function circuit 628 may be implemented as a part of another processing unit, such as CPU 602, GPU 604, DSP 606, or NPU 608.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned components of processing system 600.

In particular, in this example, memory 624 includes determining component 624A, configuring component 624B, processing component 624C, retrieving component 624D, nonlinear activation function parameters 624E, look-up table(s) 624F, and model parameters 624G (e.g., weights, biases, and other machine learning model parameters). One or more of the depicted components, as well as others not depicted, may be configured to perform various aspects of the methods described herein.

Generally, processing system 600 and/or components thereof may be configured to perform the methods described herein.

Notably, in other embodiments, aspects of processing system 600 may be omitted, such as where processing system 600 is a server computer or the like. For example, multimedia component 610, wireless connectivity 612, sensors 616, ISPs 618, and/or navigation component 620 may be omitted in other embodiments. Further, aspects of processing system 600 maybe distributed.

Note that FIG. 6 is just one example, and in other examples, alternative processing system with more, fewer, and/or different components may be used.

### Example Clauses

Implementation examples are described in the following numbered clauses:

Clause 1: A processor, comprising: a configurable nonlinear activation function circuit configured to: determine a nonlinear activation function for application to input data, determine, based on the determined nonlinear activation function, a set of parameters for the nonlinear activation function; and generate output data based on application of the set of parameters for the nonlinear activation function.

Clause 2: The processor of Clause 1, wherein the configurable nonlinear activation function circuit comprises: a first approximator configured to approximate a first function using one or more first function parameters of the set of parameters; a second approximator configured to approximate a second function using one or more second function parameters of the set of parameters; a gain multiplier configured to multiply a gain value based on one or more gain parameters of the set of parameters; and a constant adder configured to add a constant value based on a constant parameter of the set of parameters.

Clause 3: The processor of Clause 2, wherein at least one of the first approximator and the second approximator is a cubic approximator.

Clause 4: The processor of Clause 3, wherein an other one of the first approximator and the second approximator is one of a quadratic approximator or a linear approximator.

Clause 5: The processor of Clause 2, wherein both the first approximator and the second approximator are cubic approximators.

Clause 6: The processor of Clause 3, wherein an other one of the first approximator and the second approximator is configured to access a look-up table for an approximated value.

Clause 7: The processor of Clause 3, wherein an other one of the first approximator and the second approximator is configured to perform a minimum or maximum function.

Clause 8: The processor of Clause 2, wherein: the determined nonlinear activation function comprises a swish function, the gain parameters comprise a dependent parameter value of 1 and an independent parameter value of 0, the constant value is 0, the first function is quadratic, and the second function is a sigmoid look-up table.

Clause 9: The processor of Clause 2, wherein: the determined nonlinear activation function comprises a hard swish function, the gain parameters comprise a dependent parameter value of ⅙ and an independent parameter value of 0, the constant value is 3, the first function is a max function, and the second function is a min function.

Clause 10: The processor of Clause 2, wherein: the determined nonlinear activation function comprises a hyperbolic tangent (tanh) function, the gain parameters comprise a dependent parameter value of 0 and an independent parameter value of 1, the constant value is 0, the first function is quadratic, and the second function is a tanh look-up table.

Clause 11: The processor of Clause 2, wherein: the determined nonlinear activation function comprises a sigmoid function, the gain parameters comprise a dependent parameter value of 0 and an independent parameter value of 1, the constant value is 0, the first function is linear, and the second function is a sigmoid look-up table.

Clause 12: The processor of Clause 2, wherein: the determined nonlinear activation function comprises a Gaussian error linear unit (GELU) function, the gain parameters comprise a dependent parameter value of 0 and an independent parameter value of 1, the constant value is 1, the first function is cubic, and the second function is a tanh look-up table.

Clause 13: The processor of Clause 2, wherein: the determined nonlinear activation function comprises a rectified linear unit (ReLU) function, the gain parameters comprise a dependent parameter value of 0 and an independent parameter value of 1, the constant value is 0, the first function is quadratic, and the second function is a max function.

Clause 14: The processor of Clause 2, wherein: the determined nonlinear activation function comprises a rectified linear unit-six (ReLU6) function, the gain parameters comprise a dependent parameter value of 0 and an independent parameter value of 1, the constant value is 0, the first function is a max function, and the second function is a min function.

Clause 15: The processor of Clause 2, wherein: the determined nonlinear activation function comprises an exponential linear unit (ELU) function, the gain parameters comprise a dependent parameter value of 0 and an independent parameter value of α, the constant value is 0, the first function is: quadratic if an input data value is ≥0; or bypassed if the input data value is <0; the second function is: bypassed if the input data value is ≥0; or an exponential look-up table if the input data value is <0.

Clause 16: The processor of any one of Clauses 1-15, further comprising: an input memory buffer configured to store as input data one or more outputs received from a processing circuit; and an output memory buffer configured to store the generated output data for output from the configurable nonlinear activation function circuit.

Clause 17: The processor of any one of Clauses 1-16, further comprising a compute-in-memory array configured to provide the input data to the configurable nonlinear activation function circuit.

Clause 18: A method for processing input data by a configurable nonlinear activation function circuit, comprising: determining a nonlinear activation function for application to input data; determining, based on the determined nonlinear activation function, a set of parameters for a configurable nonlinear activation function circuit; and processing input data with the configurable nonlinear activation function circuit based on the set of parameters to generate output data.

Clause 19: The method of Clause 18, further comprising retrieving the set of parameters from a memory based on the determined nonlinear activation function.

Clause 20: The method of Clause 18, wherein the set of parameters includes a combination of one or more gain parameters, a constant parameter, and one or more approximation functions to apply to the input data via the configurable nonlinear activation function circuit.

Clause 21: The method of Clause 20, wherein the configurable nonlinear activation function circuit comprises: a first approximator configured to approximate a first function of the one or more approximation functions; a second approximator configured to approximate a second function of the one or more approximation functions; a first gain multiplier configured to multiply a first gain value based on the one or more gain parameters; and a constant adder configured to add a constant value based on the constant parameter.

Clause 22: The method of Clause 21, wherein the configurable nonlinear activation function circuit further comprises: a first bypass configured to bypass the first approximator; a second bypass configured to bypass the second approximator; and an input data bypass configured to bypass the first approximator and to provide the input data to the second approximator.

Clause 23: The method of Clause 22, wherein at least one of the first approximator and the second approximator is a cubic approximator.

Clause 24: The method of Clause 23, wherein an other one of the first approximator and the second approximator is one of a quadratic approximator or a linear approximator.

Clause 25: The method of Clause 23, wherein both the first approximator and the second approximator are cubic approximators.

Clause 26: The method of Clause 23, wherein an other one of the first approximator and the second approximator is configured to access a look-up table for an approximated value.

Clause 27: The method of Clause 23, wherein an other one of the first approximator and the second approximator is configured to perform a min or max function.

Clause 28: The method of Clause 21, wherein: the determined nonlinear activation function comprises a swish function, the gain parameters comprise a dependent parameter value of 1 and an independent parameter value of 0, the constant value is 0, the first function is quadratic, and the second function is a sigmoid look-up table.

Clause 29: The method of Clause 21, wherein: the determined nonlinear activation function comprises a hard swish function, the gain parameters comprise a dependent parameter value of ⅙ and an independent parameter value of 0, the constant value is 3, the first function is a max function, and the second function is a min function.

Clause 30: The method of Clause 21, wherein: the determined nonlinear activation function comprises a Gaussian error linear unit (GELU) function, the gain parameters comprise a dependent parameter value of 0 and an independent parameter value of 1, the constant value is 1, the first function is cubic, and the second function is a tanh look-up table.

Clause 31: The method of Clause 21, wherein: the determined nonlinear activation function comprises a hyperbolic tangent (tanh) function, the gain parameters comprise a dependent parameter value of 0 and an independent parameter value of 1, the constant value is 0, the first function is quadratic, and the second function is a tanh look-up table.

Clause 32: The method of Clause 21, wherein: the determined nonlinear activation function comprises a sigmoid function, the gain parameters comprise a dependent parameter value of 0 and an independent parameter value of 1, the constant value is 0, the first function is linear, and the second function is a sigmoid look-up table.

Clause 33: The method of Clause 21, wherein: the determined nonlinear activation function comprises a rectified linear unit (ReLU) function, the gain parameters comprise a dependent parameter value of 0 and an independent parameter value of 1, the constant value is 0, the first function is quadratic, and the second function is a max function.

Clause 34: The method of Clause 21, wherein: the determined nonlinear activation function comprises a rectified linear unit-six (ReLU6) function, the gain parameters comprise a dependent parameter value of 0 and an independent parameter value of 1, the constant value is 0, the first function is a max function, and the second function is a min function.

Clause 35: The method of Clause 21, wherein: the determined nonlinear activation function comprises an exponential linear unit (ELU) function, the gain parameters comprise a dependent parameter value of 0 and an independent parameter value of α, the constant value is 0, the first function is: quadratic if an input data value is ≥0; or bypassed if the input data value is <0; the second function is: bypassed if the input data value is ≥0; or an exponential look-up table if the input data value is <0.

Clause 36: The method of Clause 21, further comprising receiving the input data from a compute-in-memory (CIM) array.

Clause 37: A configurable nonlinear activation function circuit configured to process a nonlinear activation function according to any configuration of Table 1.

Clause 38: A circuit block, comprising: a configurable nonlinear activation function circuit; and a selectable bypass.

Clause 39: The circuit block of Clause 38, wherein the configurable nonlinear activation function circuit is configured to process a nonlinear activation function according to any configuration of Table 1.

Clause 40: The circuit block of Clause 38, wherein the circuit block may be configured according to any configuration of Table 2.

Clause 41: A processing system, comprising: a memory comprising computer-executable instructions; and one or more processors configured to execute the computer-executable instructions and cause the processing system to perform a method in accordance with any one of Clauses 18-36.

Clause 42: A processing system, comprising means for performing a method in accordance with any one of Clauses 18-36.

Clause 43: A non-transitory computer-readable medium comprising computer-executable instructions that, when executed by one or more processors of a processing system, cause the processing system to perform a method in accordance with any one of Clauses 18-36.

Clause 44: A computer program product embodied on a computer-readable storage medium comprising code for performing a method in accordance with any one of Clauses 18-36.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor, comprising:
a configurable nonlinear activation function circuit configured to:
determine a nonlinear activation function for application to input data;
determine, based on the determined nonlinear activation function, a set of parameters for the nonlinear activation function; and
generate output data based on application of the set of parameters for the nonlinear activation function.

2. The processor of claim 1, wherein the configurable nonlinear activation function circuit comprises:
a first approximator configured to approximate a first function using one or more first function parameters of the set of parameters;
a second approximator configured to approximate a second function using one or more second function parameters of the set of parameters;
a gain multiplier configured to multiply a gain value based on one or more gain parameters of the set of parameters; and
a constant adder configured to add a constant value based on a constant parameter of the set of parameters.

3. The processor of claim 2, wherein at least one of the first approximator and the second approximator is a cubic approximator.

4. The processor of claim 3, wherein an other one of the first approximator and the second approximator is one of a quadratic approximator or a linear approximator.

5. The processor of claim 2, wherein both the first approximator and the second approximator are cubic approximators.

6. The processor of claim 3, wherein an other one of the first approximator and the second approximator is configured to access a look-up table for an approximated value.

7. The processor of claim 3, wherein an other one of the first approximator and the second approximator is configured to perform a minimum or maximum function.

8. The processor of claim 2, wherein:
the determined nonlinear activation function comprises a swish function,
the gain parameters comprise a dependent parameter value of 1 and an independent parameter value of 0,
the constant value is 0,
the first function is quadratic, and
the second function is a sigmoid look-up table.

9. The processor of claim 2, wherein:
the determined nonlinear activation function comprises a hard swish function,
the gain parameters comprise a dependent parameter value of ⅙ and an independent parameter value of 0,
the constant value is 3,
the first function is a max function, and
the second function is a min function.

10. The processor of claim 2, wherein:
the determined nonlinear activation function comprises a hyperbolic tangent (tanh) function,
the gain parameters comprise a dependent parameter value of 0 and an independent parameter value of 1,
the constant value is 0,
the first function is quadratic, and
the second function is a tanh look-up table.

11. The processor of claim 2, wherein:
the determined nonlinear activation function comprises a sigmoid function,
the gain parameters comprise a dependent parameter value of 0 and an independent parameter value of 1,
the constant value is 0,
the first function is linear, and
the second function is a sigmoid look-up table.

12. The processor of claim 2, wherein:
the determined nonlinear activation function comprises a Gaussian error linear unit (GELU) function,
the gain parameters comprise a dependent parameter value of 0 and an independent parameter value of 1,
the constant value is 1,
the first function is cubic, and
the second function is a tanh look-up table.

13. The processor of claim 2, wherein:
the determined nonlinear activation function comprises a rectified linear unit (ReLU) function,
the gain parameters comprise a dependent parameter value of 0 and an independent parameter value of 1,
the constant value is 0,
the first function is quadratic, and
the second function is a max function.

14. The processor of claim 2, wherein:
the determined nonlinear activation function comprises a rectified linear unit-six (ReLU6) function,
the gain parameters comprise a dependent parameter value of 0 and an independent parameter value of 1,
the constant value is 0,
the first function is a max function, and
the second function is a min function.

15. The processor of claim 2, wherein:
the determined nonlinear activation function comprises an exponential linear unit (ELU) function,
the gain parameters comprise a dependent parameter value of 0 and an independent parameter value of α,
the constant value is 0,
the first function is:
quadratic if an input data value is ≥0; or
bypassed if the input data value is <0;
the second function is:
bypassed if the input data value is ≥0; or
an exponential look-up table if the input data value is <0.

16. The processor of claim 1, further comprising:
an input memory buffer configured to store as input data one or more outputs received from a processing circuit; and
an output memory buffer configured to store the generated output data for output from the configurable nonlinear activation function circuit.

17. The processor of claim 1, further comprising a compute-in-memory array configured to provide the input data to the configurable nonlinear activation function circuit.

18. A method for processing input data by a configurable nonlinear activation function circuit, comprising:
determining a nonlinear activation function for application to input data;
determining, based on the determined nonlinear activation function, a set of parameters for a configurable nonlinear activation function circuit; and
processing input data with the configurable nonlinear activation function circuit based on the set of parameters to generate output data.

19. The method of claim 18, further comprising retrieving the set of parameters from a memory based on the determined nonlinear activation function.

20. The method of claim 18, wherein the set of parameters includes a combination of one or more gain parameters, a constant parameter, and one or more approximation functions to apply to the input data via the configurable nonlinear activation function circuit.

21. The method of claim 20, wherein the configurable nonlinear activation function circuit comprises:
a first approximator configured to approximate a first function of the one or more approximation functions;
a second approximator configured to approximate a second function of the one or more approximation functions;
a first gain multiplier configured to multiply a first gain value based on the one or more gain parameters; and
a constant adder configured to add a constant value based on the constant parameter.

22. The method of claim 21, wherein the configurable nonlinear activation function circuit further comprises:
a first bypass configured to bypass the first approximator;
a second bypass configured to bypass the second approximator; and
an input data bypass configured to bypass the first approximator and to provide the input data to the second approximator.

23. The method of claim 22, wherein at least one of the first approximator and the second approximator is a cubic approximator.

24. The method of claim 23, wherein an other one of the first approximator and the second approximator is one of a quadratic approximator or a linear approximator.

25. The method of claim 23, wherein both the first approximator and the second approximator are cubic approximators.

26. The method of claim 23, wherein an other one of the first approximator and the second approximator is configured to access a look-up table for an approximated value.

27. The method of claim 23, wherein an other one of the first approximator and the second approximator is configured to perform a min or max function.

28. The method of claim 21, wherein:
the determined nonlinear activation function comprises a swish function,
the gain parameters comprise a dependent parameter value of 1 and an independent parameter value of 0,
the constant value is 0,
the first function is quadratic, and
the second function is a sigmoid look-up table.

29. The method of claim 21, wherein:
the determined nonlinear activation function comprises a hard swish function,
the gain parameters comprise a dependent parameter value of ⅙ and an independent parameter value of 0,
the constant value is 3,
the first function is a max function, and
the second function is a min function.

30. The method of claim 21, wherein:
the determined nonlinear activation function comprises a Gaussian error linear unit (GELU) function,
the gain parameters comprise a dependent parameter value of 0 and an independent parameter value of 1,
the constant value is 1,
the first function is cubic, and
the second function is a tanh look-up table.
